(19) United States
(12) Patent Application Publication
(10) Pub. No.: US 2015/0159019 A1
(43) Pub. Date: Jun. 11, 2015

(54) COLORING COMPOUND AND INK, COLOR FILTER RESIST COMPOSITION, AND THERMAL TRANSFER RECORDING INK SHEET CONTAINING SAID COLORING COMPOUND

(71) Applicant: CANON KABUSHIKI KAISHA, Tokyo (JP)

(72) Inventors: Akiko Kitao, Kawasaki-shi (JP); Ryuji Higashi, Kawasaki-shi (JP); Taichi Shintou, Saitama-shi (JP); Takeshi Miyazaki, Ebina-shi (JP)

(73) Assignee: CANON KABUSHIKI KAISHA, Tokyo (JP)

(21) Appl. No.: 14/419,577

(22) PCT Filed: Aug. 21, 2013
(86) PCT No.: PCT/JP2013/072931

§ 371 Date: Feb. 4, 2015

(30) Foreign Application Priority Data
Aug. 22, 2012 (JP) 2012-183476

(51) Int. Cl. C09B 47/04; G02B 1/04; C08K 5/544; C09D 11/00

(52) U.S. Cl. CPC C09B 47/04; C09D 11/00; G02B 1/04; C08K 5/5442

(57) ABSTRACT

The present invention provides a coloring compound that exhibits an excellent chromogenicity and provides an ink, a color filter resist composition, and a thermal transfer recording ink sheet that contain this coloring compound.

The coloring compound has the structure represented by general formula (1), and the ink, color filter resist composition, and thermal transfer recording ink sheet contain this coloring compound.

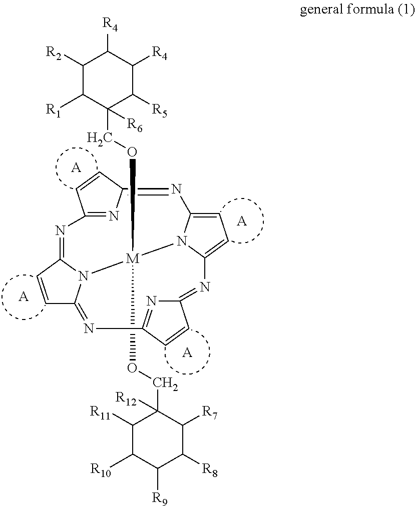

### TECHNICAL FIELD

The present invention relates to a coloring compound and to an ink, a color filter resist composition, and a thermal transfer recording ink sheet that contain this coloring compound.

### BACKGROUND ART

The requirements for higher color image quality, most prominently in color liquid crystal displays, have been increasing in recent years. Color filters are essential for the display of color by liquid crystal displays and are thus crucial elements that govern the performance of liquid crystal displays.

In the case of liquid crystal displays that use pigments, the transmissivity for the backlight ends up being lowered by the pigment, and this has made it quite difficult to increase the lightness of the color filter. In addition, because pigments are insoluble in organic solvents and polymers, they are present in the colored resist composition in a dispersed state. However, it is difficult to stabilize their dispersity.

Dyes, on the other hand, are often generally soluble in organic solvents and polymers, and, through the selection of the type of dye, can also be stabilized in the colored resist composition without inducing aggregation. As a consequence, the dye is dispersed at the molecular level in a color filter that has been fabricated using a resist composition containing a dye as the colorant, and as a result the appearance of depolarization effects is suppressed and the transmissivity for the backlight is also excellent.

To date, a color filter that uses as its colorant a phthalocyanine color matter having a central Si atom has been reported for the purpose of making possible an image display having excellent spectral characteristics and a high display contrast (refer to Patent Literature 1). However, in order to display images at even higher definition, the development of coloring compounds having even better chromogenicities is required.

Improvements in coloring compounds are also required in fields other than the field of color filters. An example here is the image forming method that uses thermal transfer recording.

Thermal transfer recording is a method in which image formation is performed using a thermal transfer sheet that has a color material layer containing a thermally transferable coloring compound on a sheet-form substrate. Specifically, this thermal transfer sheet is overlaid on an image receiving sheet that has a color matter receiving layer on its surface and image formation is performed by heating the thermal transfer sheet to thereby transfer the color matter in the thermal transfer sheet to the image receiving sheet. In this thermal transfer recording method, the coloring compound contained in the thermal transfer sheet and in the ink composition for the thermal transfer sheet is a critical material because it influences the transfer recording speed, the image quality of the recorded information, and the storage stability.

### CITATION LIST

### Patent Literature

[PTL 1] Japanese Patent Application Laid-open No. 2008-176311

### SUMMARY OF INVENTION

### Technical Problems

An object of the present invention is to solve the problems indicated above. That is, an object of the present invention is to provide a coloring compound that exhibits an excellent chromogenicity and to provide an ink, a color filter resist composition, and a thermal transfer recording ink sheet that contain this coloring compound.

### Solution to Problem

This object can be achieved by the following inventions.

A first aspect of the present invention relates to a coloring compound that has the structure represented by the following general formula (1).

A second aspect of the present invention relates to an ink that contains a dispersion medium and the coloring compound with general formula (1).

A third aspect of the present invention relates to a color filter resist composition that contains at least either one of a binder resin and a polymerizable monomer and the coloring compound with general formula (1).

A fourth aspect of the present invention relates to a thermal transfer recording ink sheet that has a substrate and a color material layer formed on the substrate, the color material layer containing the coloring compound with general formula (1).

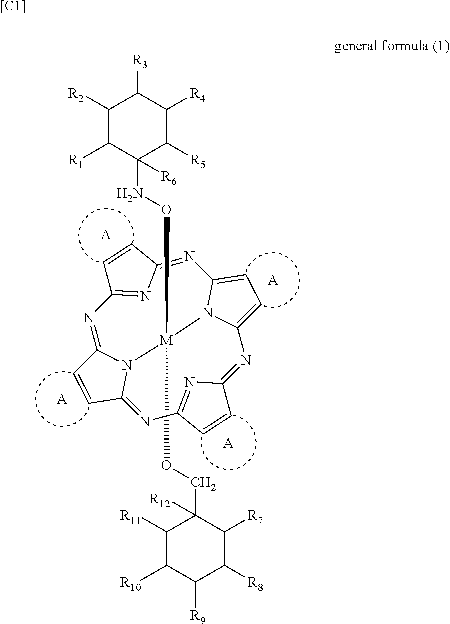

In general formula (1),

R₁ to R₆ each independently represent a hydrogen atom, an alkyl group, a hydroxyl group, an amino group, a carboxy group, an aryl group, an aralkyl group, —CH₂OH, or —CH₂—O—CH═CH₂, or an atomic group as required to form a saturated alicyclic hydrocarbon ring by the bonding of any two or more of R₂ to R₆ to each other;
R₇ to R₁₂ each independently represent a hydrogen atom, an alkyl group, a hydroxyl group, an amino group, a carboxy group, an aryl group, an aralkyl group, —CH₂OH, or —CH₂—O—CH═CH₂, or an atomic group as required to form a saturated alicyclic hydrocarbon ring by the bonding of any two or more of R₇ to R₁₂ to each other;

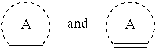

each independently represent either one of a substituted or unsubstituted aryl ring and a heterocycle that contains 1 or 2 nitrogen atoms; and
M represents at least one metal atom selected from the group consisting of Si, Ge, and Sn.

### Advantageous Effects of Invention

The present invention can provide a coloring compound that exhibits an excellent chromogenicity. By incorporating the coloring compound of the present invention, the present invention can provide an ink that exhibits an excellent chromogenicity, a color filter resist composition that exhibits an excellent chromogenicity, and a thermal transfer recording ink sheet that exhibits an excellent chromogenicity.

### DESCRIPTION OF EMBODIMENTS

The present invention is described in additional detail in the following through embodiments.

As a result of intensive investigations carried out in order to solve the problems identified above, the present inventors discovered that a coloring compound having the structure given by general formula (1) below exhibits an excellent chromogenicity. It was also discovered that an ink that exhibits an excellent chromogenicity, a color filter resist composition that exhibits an excellent chromogenicity, and a thermal transfer recording ink sheet that exhibits an excellent chromogenicity can be obtained by using the coloring compound with the structure given by general formula (1). The present invention was achieved based on these discoveries.

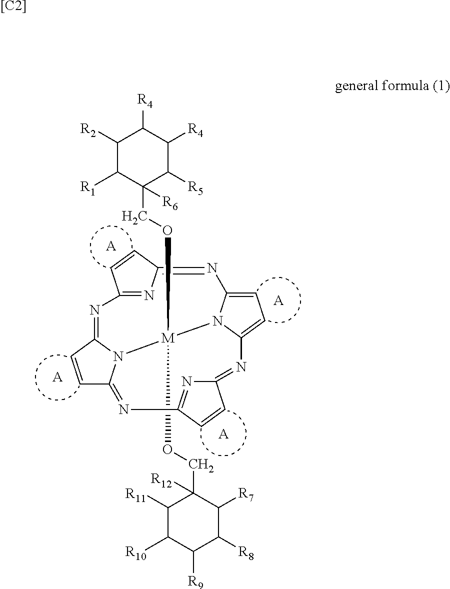

In general formula (1),

R₁ to R₆ each independently represent a hydrogen atom, an alkyl group, a hydroxyl group, an amino group, a carboxy group, an aryl group, an aralkyl group, —CH₂OH, or —CH₂—O—CH═CH₂, or an atomic group as required to form a saturated alicyclic hydrocarbon ring by the bonding of any two or more of R₁ to R₆ to each other;
R₇ to R₁₂ each independently represent a hydrogen atom, an alkyl group, a hydroxyl group, an amino group, a carboxy group, an aryl group, an aralkyl group, —CH₂OH, or —CH₂—O—CH═CH₂, or an atomic group as required to form a saturated alicyclic hydrocarbon ring by the bonding of any two or more of R₇ to R₁₂ to each other;

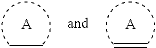

each independently represent either one of a substituted or unsubstituted aryl ring and a heterocycle that contains 1 or 2 nitrogen atoms; and
M represents at least one metal atom selected from the group consisting of Si, Ge, and Sn.

<The Coloring Compound>

The coloring compound having the structure with general formula (1) will be described first.

The alkyl group encompassed by R₁ to R₁₂ in general formula (1) is not particularly limited and can be exemplified by C₁ to C₂₀ alkyl groups that may be saturated or unsaturated, straight chain, branched, or cyclic, and primary, secondary, or tertiary, e.g., the methyl group, ethyl group, n-propyl group, iso-propyl group, n-butyl group, sec-butyl group, tert-butyl group, octyl group, dodecyl group, nonadecyl group, cyclobutyl group, cyclopentyl group, cyclohexyl group, methylcyclohexyl group, 2-ethylpropyl group, 2-ethylhexyl group, and cyclohexenylethyl group.

The aryl group encompassed by R₁ to R₁₂ in general formula (1) is not particularly limited and can be exemplified by the phenyl group. This aryl group may be substituted and the substituted aryl group can be exemplified by the tolyl group and the o-xylyl group.

The aralkyl group encompassed by R₁ to R₁₂ in general formula (1) is not particularly limited and can be exemplified by the benzyl group.

The amino group encompassed by R₁ to R₁₂ in general formula (1) is not particularly limited and can be exemplified by the unsubstituted amino group, by monosubstituted amino groups such as the N-butylamino group and N-benzylamino group, and by disubstituted amino groups such as the N,N-diethylamino group.

Viewed from the standpoint of the chromogenicity, the coloring compound having the structure shown by general formula (1) preferably satisfies the following condition i) or ii):

(i) R₁ to R₆ are atomic groups as required to form a saturated cyclic hydrocarbon ring by the bonding of any two or more of R₁ to R₆ to each other;

(ii) R₇ to R₁₂ are atomic groups as required to form a saturated cyclic hydrocarbon ring by the bonding of any two or more of R₇ to R₁₂ to each other.

In such a structure the saturated cyclic hydrocarbon ring having R₁ to R₆ or the saturated cyclic hydrocarbon ring having R₇ to R₁₂ takes the form of a polycyclic saturated cyclic hydrocarbon ring.

The following rings (1) to (16) are specific examples of the saturated cyclic hydrocarbon ring having R₁ to R₆ in general formula (1) or the saturated cyclic hydrocarbon ring having R₇ to R₁₂ in general formula (1). In the following examples, symbol * shows a binding site for methylene.

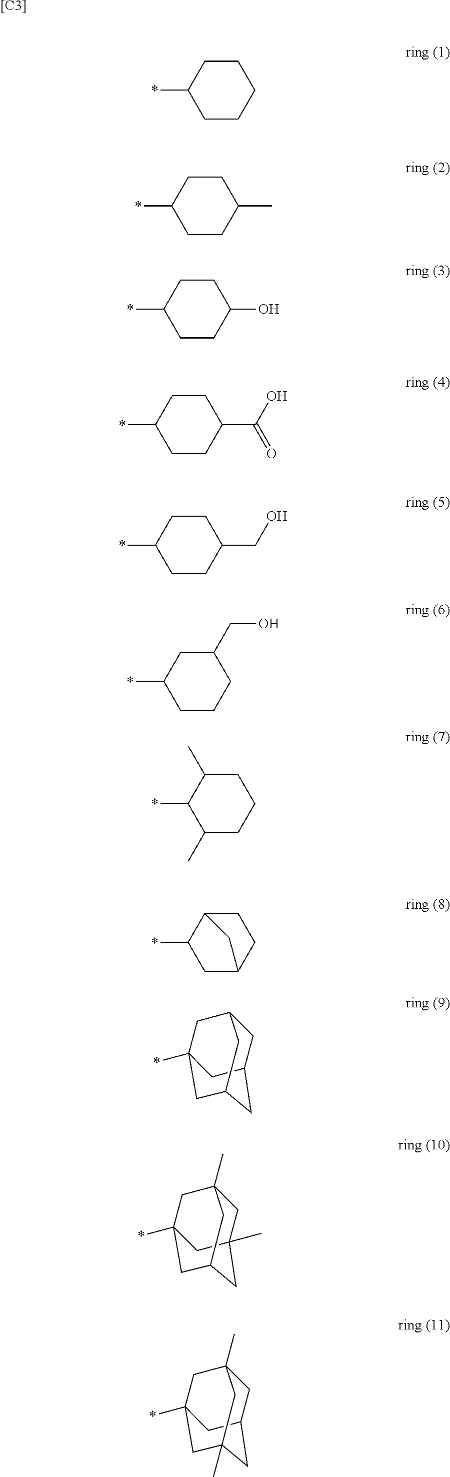

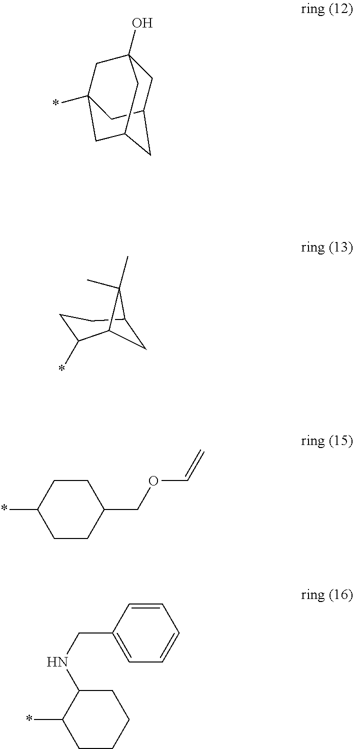

From the standpoint of the chromogenicity, ring (1), ring (8), and ring (9) are preferred among rings (1) to (16), while ring (8) and ring (9) are more preferred and ring (9) [the adamantane ring] is even more preferred.

The aryl ring represented by

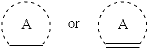

in general formula (1) is not particularly limited and can be exemplified by the benzene ring and naphthyl ring. These rings may also be substituted insofar as this does not affect the chromogenicity. The specific substituent can be exemplified by alkyl groups such as the methyl group, propyl group, and tert-butyl group; alkoxy groups such as the methoxy group, ethoxy group, propoxyl group, butoxy group, and hexyloxy group; the nitro group; and halogen atoms such as the chlorine atom. Viewed from a synthesis standpoint, these substituents are not necessarily regularly directed and various isomers may be obtained. The variation in these isomers does not exercise a significant effect on the chromogenicity.

The heterocycle having 1 or 2 nitrogen atoms represented by

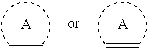

in general formula (1) is not particularly limited and can be exemplified by the pyridine ring, pyrazine ring, pyrrolidine ring, piperidine ring, azepane ring, and azocane ring.

Preferred among the preceding from the standpoint of the chromogenicity are the substituted or unsubstituted benzene ring, pyridine ring, or pyrazine ring, while the substituted or unsubstituted benzene ring is particularly preferred and a benzene ring bearing the tert-butyl group is even more preferred.

The M in general formula (1) represents at least one metal atom selected from the group consisting of Si, Ge, and Sn. Among these, Si is preferred for the metal atom from the standpoint of the chromogenicity.

The coloring compounds according to the present invention having the structure given by general formula (1) can be synthesized with reference to the known methods described in, for example, Polymer Journal, Vol. 27, No. 11, pp. 1079-1084 (1995) and Angew. Chem. Int. Ed., Vol. 37, No. 8, pp. 1092-1094 (1998).

An embodiment of a method for producing the coloring compound having the structure given by general formula (1) is provided below, but this should not be taken to mean that the production method is limited to or by this.

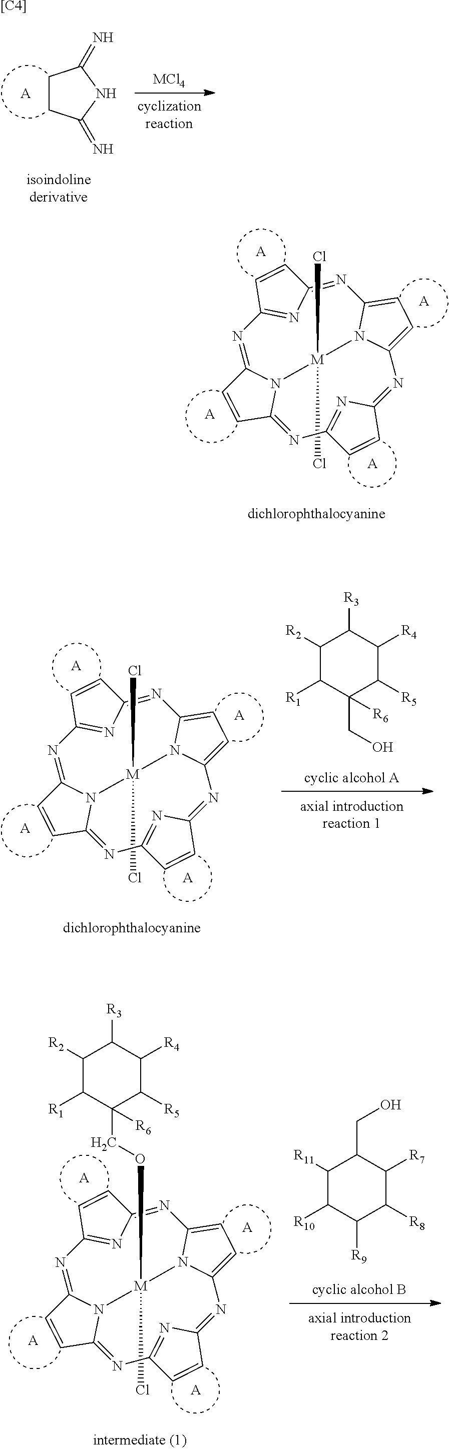

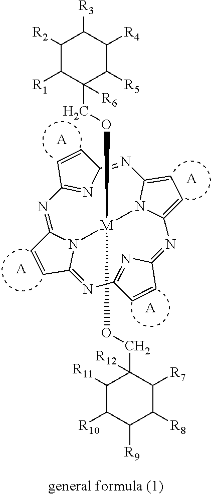

The cyclization reaction will be considered in detail first.

The isoindoline derivative can be readily synthesized from a 1,2-dicyanobenzene derivative by the known method described in Journal of Heterocycle Chemistry, pp. 1403-1405 (1970).

In addition, the dichlorophthalocyanine can be readily synthesized by reacting the isoindoline derivative and metal halide at at least 200° C. in a solvent such as quinoline or chloronaphthalene.

The axial introduction reactions 1 and 2 are considered in detail below.

The coloring compound having the structure given by general formula (1) can be obtained by an axial introduction reaction 1, in which the dichlorophthalocyanine is reacted with a cyclic alcohol A, and an axial introduction reaction 2, in which the intermediate (1) is reacted with a cyclic alcohol B.

The axial introduction reaction 1 can be run in the absence of a solvent, but is preferably run in the presence of a solvent. The solvent should not participate in the reaction but otherwise is not particularly limited and can be exemplified by toluene, xylene, monochlorobenzene, dichlorobenzene, pyridine, and quinoline.

A mixture of two or more solvents may also be used, and the mixing ratio may be freely selected when a mixture is used. The amount of use (mass basis) of the reaction solvent is preferably from 0.1- to 1000-times that of the dichlorophthalocyanine and is more preferably from 1.0- to 150-times that of the dichlorophthalocyanine.

The reaction temperature in axial introduction reaction 1 is preferably in the range from −80° C. to 250° C. and is more preferably from −20° C. to 150° C. The reaction can ordinarily be completed within 10 hours.

In the case of axial introduction reaction 1, the reaction runs rapidly when an optional base is added.

The base used in the axial introduction reaction 1 can be specifically exemplified by metal alkoxides such as potassium tert-butoxide, sodium tert-butoxide, sodium methoxide, and sodium ethoxide; organic bases such as piperidine, pyridine, 2-methylpyridine, diethylamine, triethylamine, isopropylethylamine, potassium acetate, and 1,8-diazabicyclo[5.4.0]undec-7-ene (abbreviated as DBU below); organic bases such as n-butyllithium and tert-butylmagnesium chloride; and inorganic bases such as sodium borohydride, sodium metal, sodium hydride, and sodium carbonate. Preferred among the preceding are potassium tert-butoxide, sodium hydride, sodium methoxide, sodium ethoxide, and piperidine, while sodium hydride and piperidine are more preferred because they are inexpensive and easy to handle.

The amount of use of the base used in the axial introduction reaction 1 is preferably from 0.1 to 1.5 equivalents, more preferably from 0.2 to 1.3 equivalents, and even more preferably from 0.3 to 1.1 equivalents, in each case with reference to the cyclic alcohol A.

The axial introduction reaction 2 step is ordinarily carried out directly after the completion of the reaction in the axial introduction reaction 1.

The reaction temperature in the axial introduction reaction 2 is preferably in the range from −80° C. to 250° C. and more preferably −20° C. to 150° C. The reaction can ordinarily be completed within 10 hours.

In the case of the axial introduction reaction 2, the reaction runs rapidly when an optional base is added.

The base used in the axial introduction reaction 2 is specifically exemplified by the bases provided as examples of the base that can be used in the axial introduction reaction 1.

The amount of use of the base used in the axial introduction reaction 2 is preferably from 0.1 to 10 equivalents, more preferably 0.5 to 5.0 equivalents, and even more preferably from 0.8 to 2.0 equivalents, in each case with reference to the cyclic alcohol B.

After the completion of the reaction, the obtained solid is filtered off; the residue is washed with a nonpolar solvent such as n-hexane, n-heptane, or toluene; and washing is then carried out with a polar solvent such as an alcohol and then with, for example, ion-exchanged water, to obtain the coloring compound with the structure shown in general formula (1).

In conformity with the use application, a single coloring compound having the structure given by general formula (1) may be used in the present invention or two or more may be used in combination, in order to adjust, for example, the color tone and so forth. Combinations with two or more known pigments and/or dyes may also be used.

Coloring compounds (1) to (41) are given below as preferred specific examples of the coloring compound of the present invention, but the present invention is not limited to or by the examples provided below.

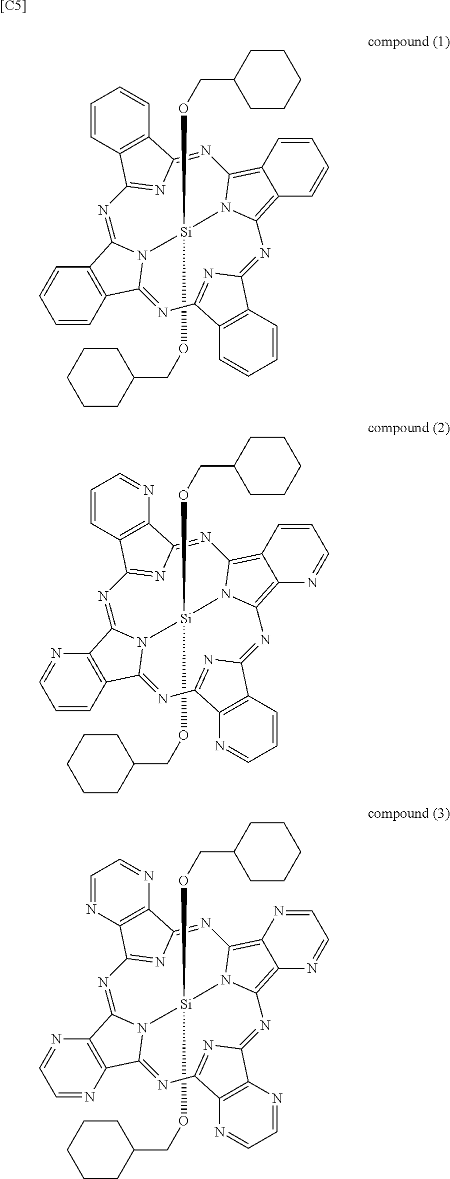

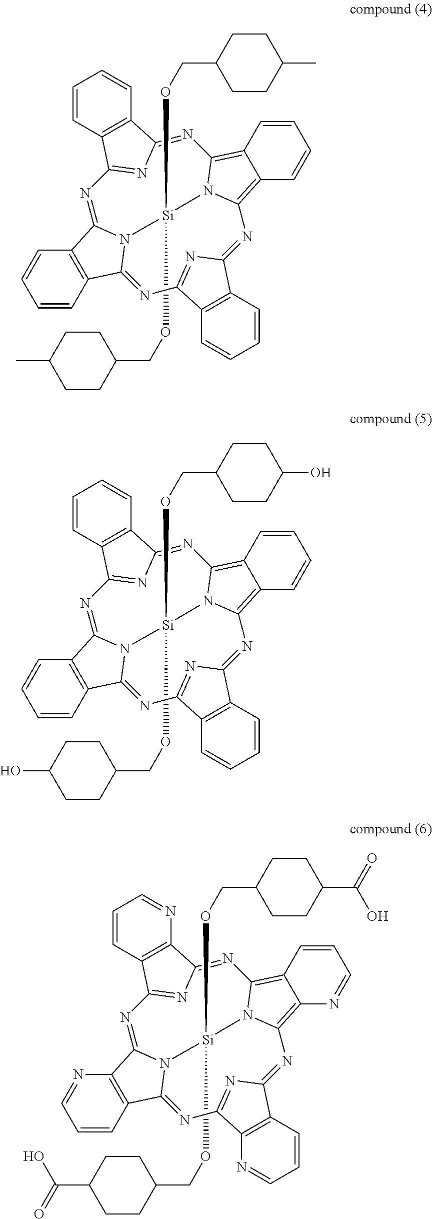

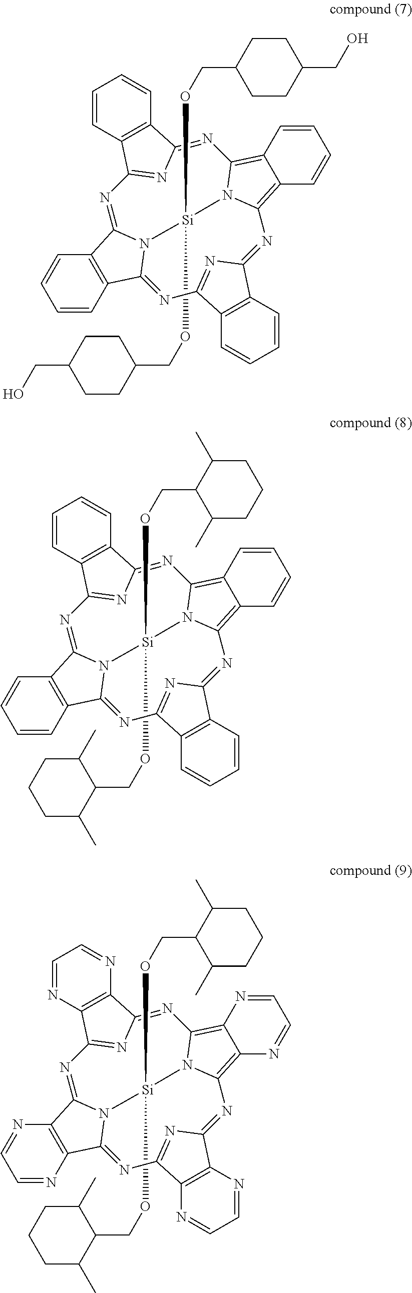

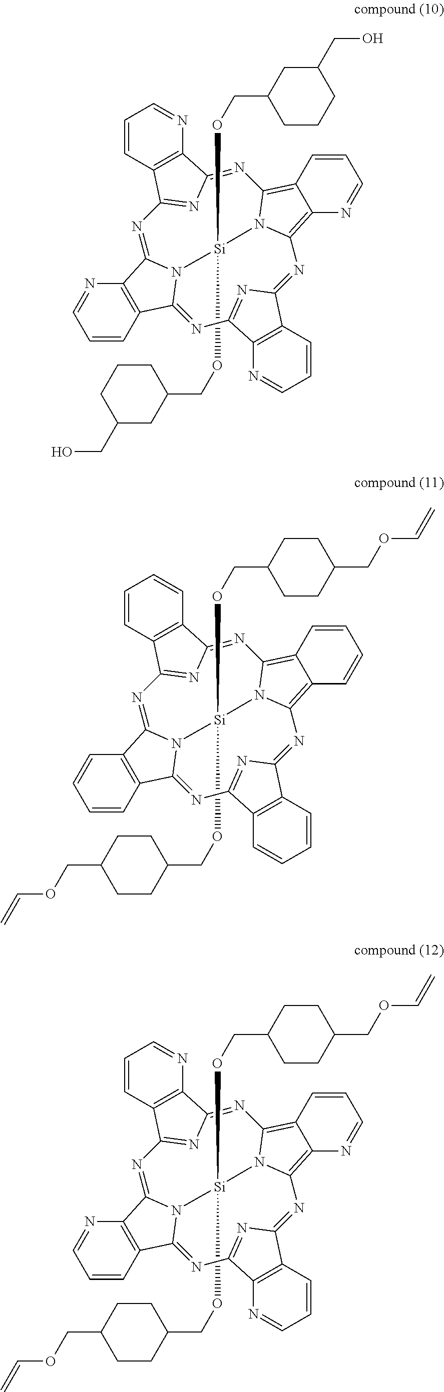

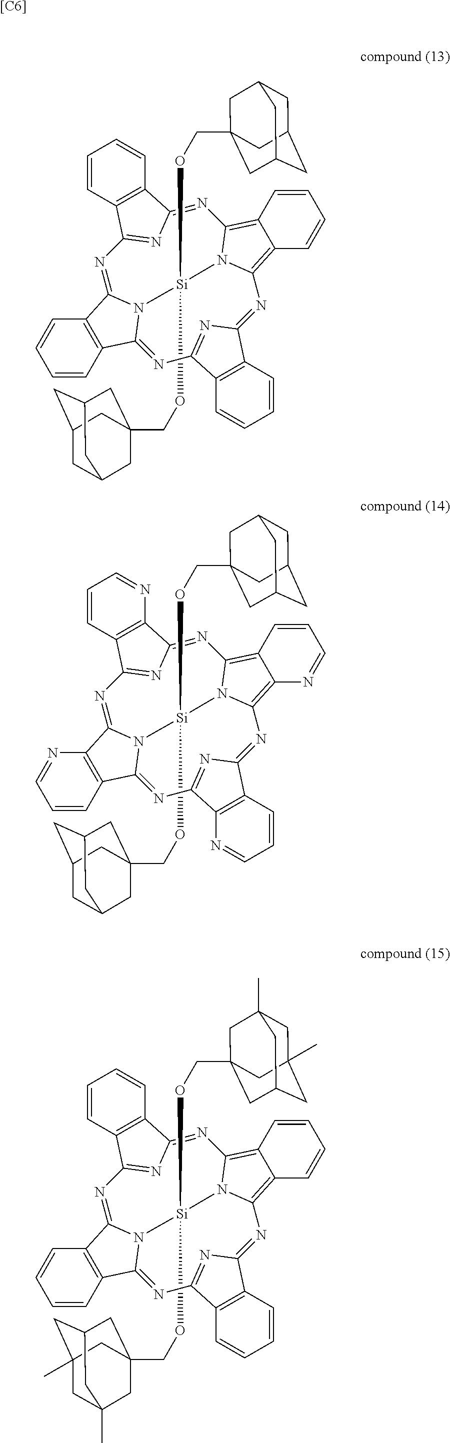

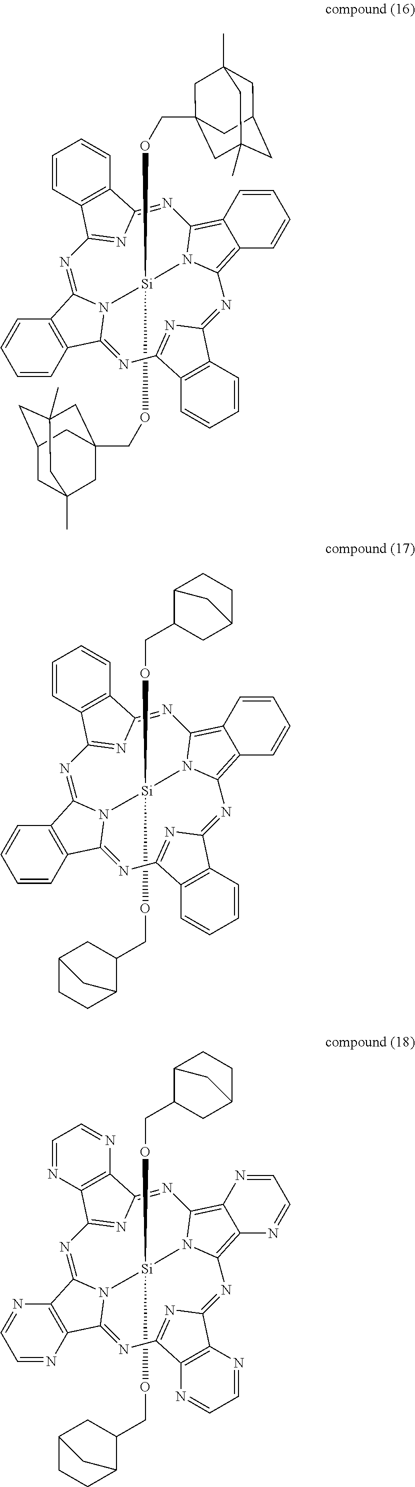

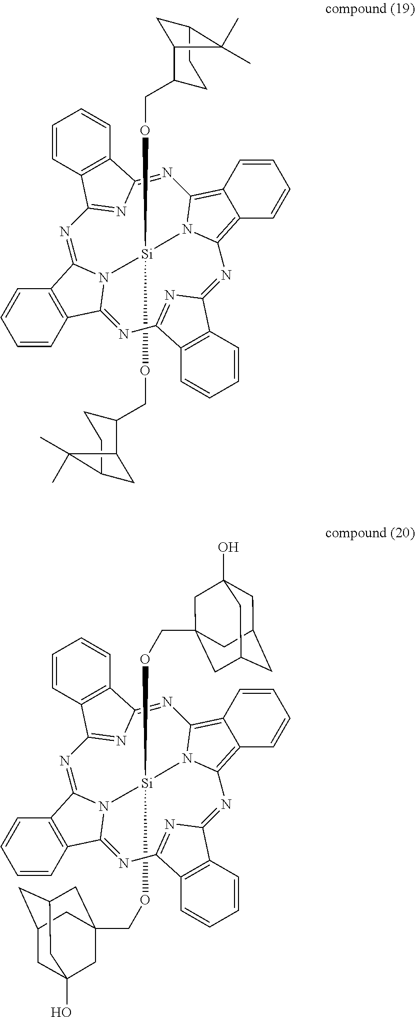

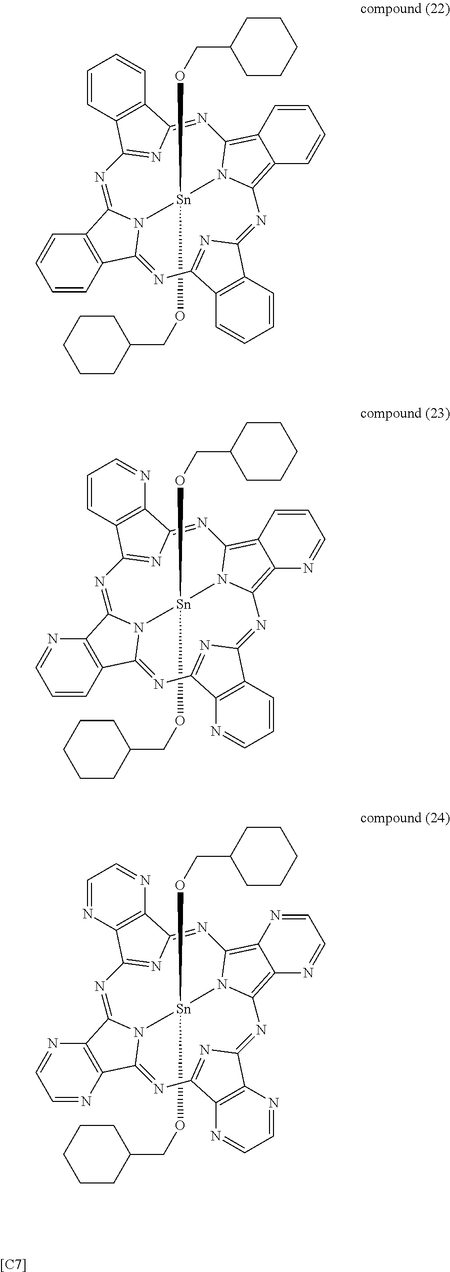

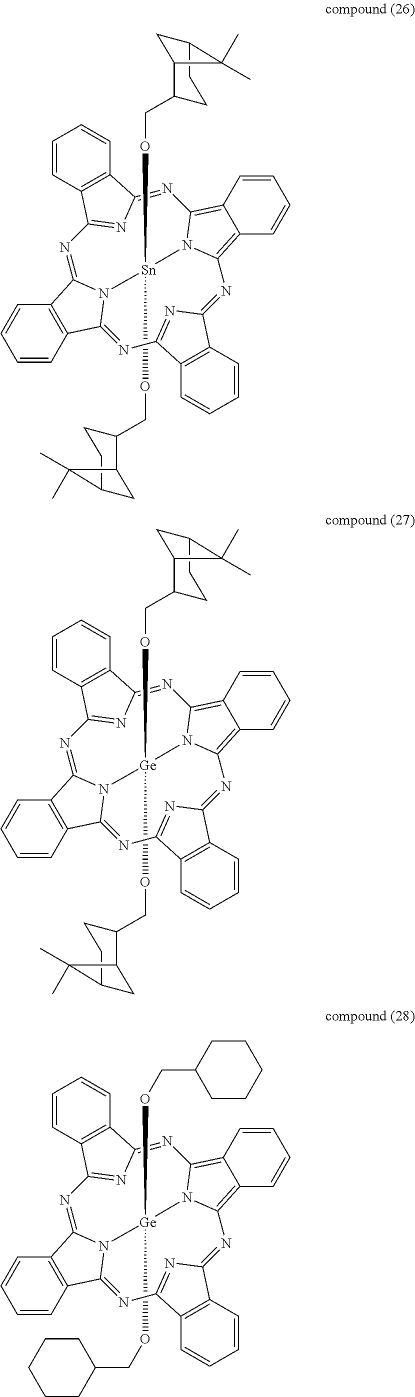

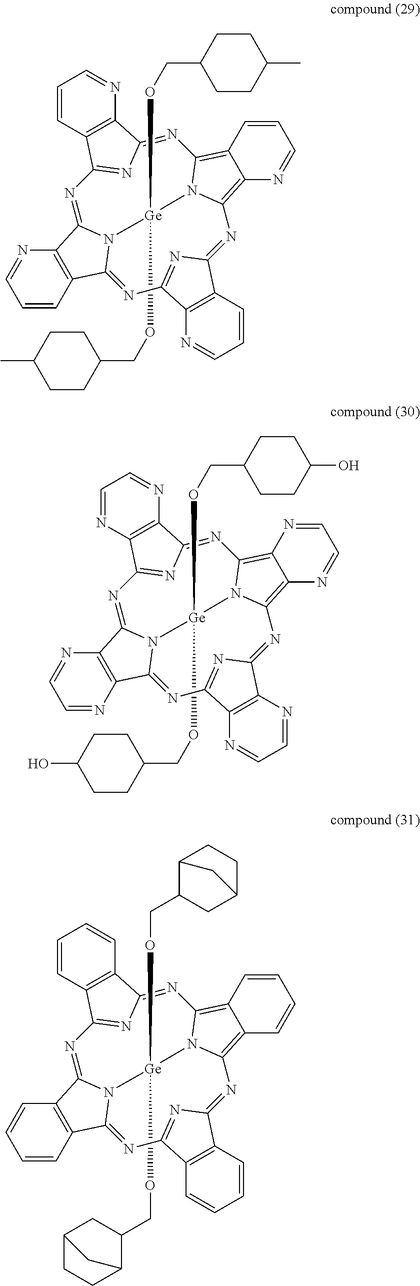

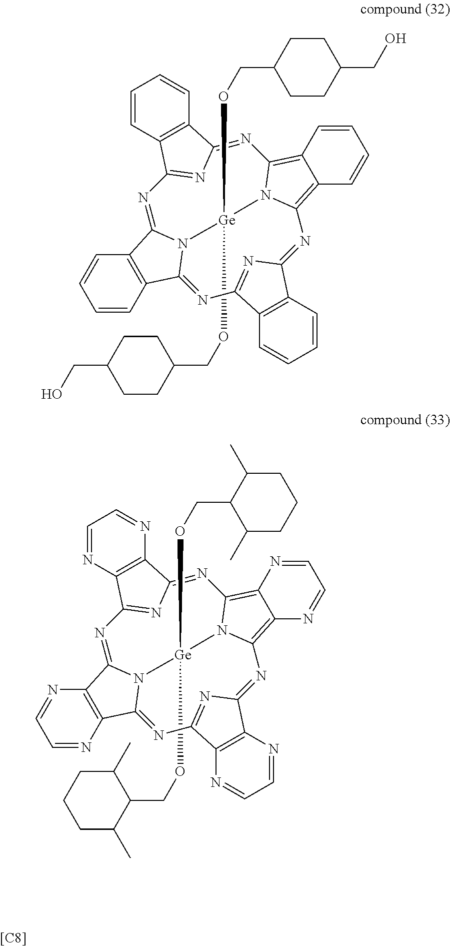

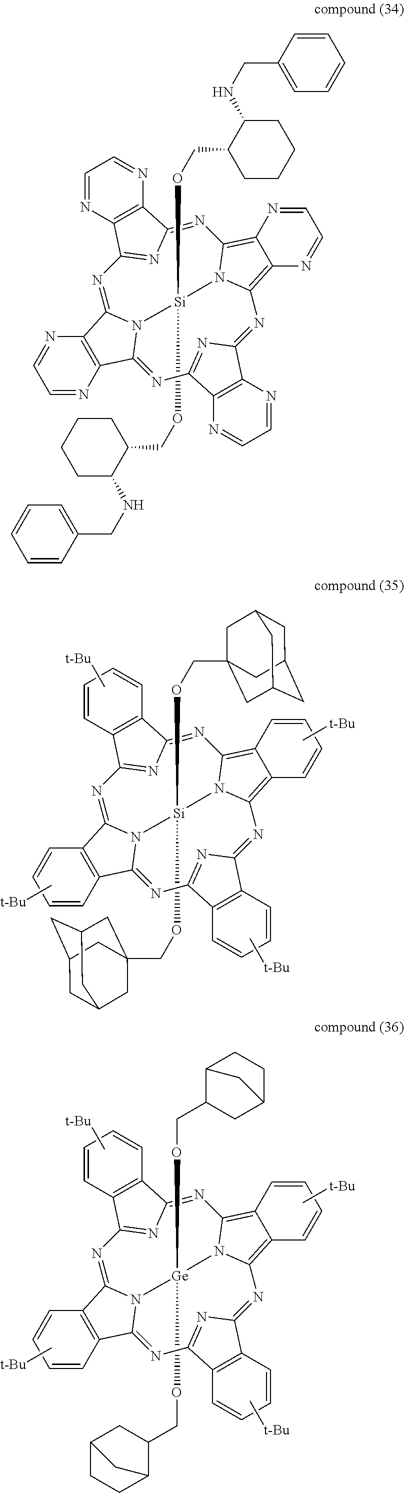

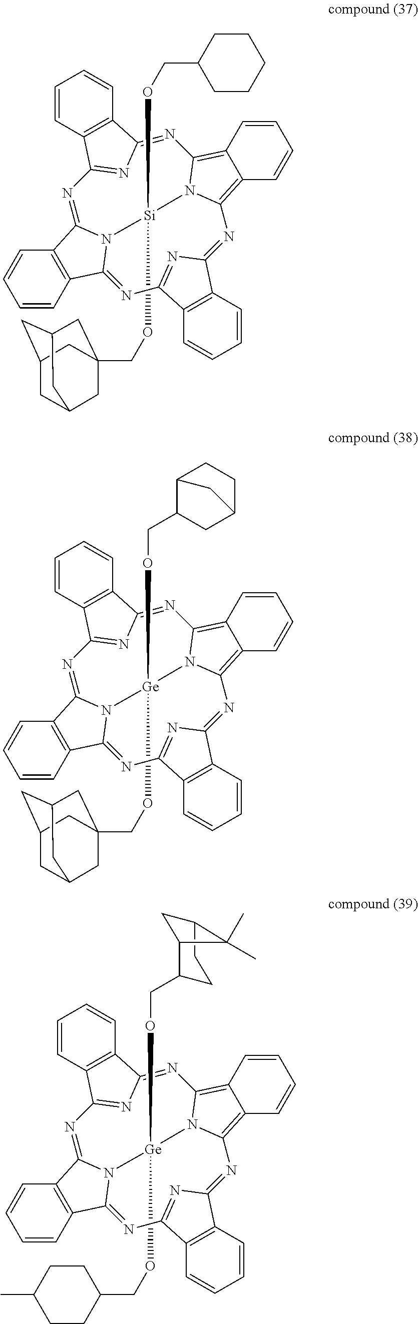

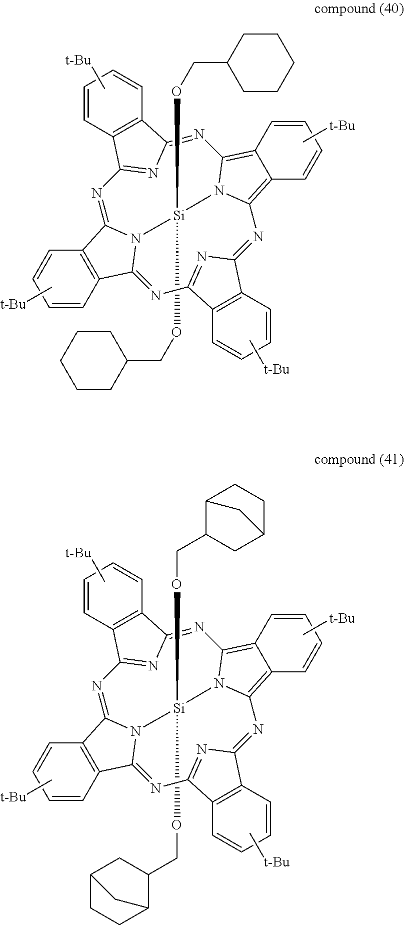

t-Bu in the preceding structures represents the tert-butyl group.

<The Ink>

The ink of the present invention will now be described.

The coloring compound of the present invention with general formula (1) exhibits an excellent chromogenicity and is well suited for application as an ink colorant.

The ink of the present invention contains a dispersion medium and a coloring compound with the structure given in general formula (1).

Other constituent components of the ink of the present invention may each be selected based on the use application of the ink of the present invention, and additives may be added within a range that does not impair the characteristics for the particular application that uses the ink.

The ink of the present invention can be very suitably used most prominently as an inkjet ink, but also as a printing ink, a coating or paint, an ink for writing implements, and so forth. Among these, it is particularly well suited as an ink for application in a color filter resist and as an ink for application in a thermal transfer recording ink sheet, which are described below.

The ink of the present invention can be produced, for example, as described in the following.

The coloring compound of the present invention and as necessary another coloring compound, an emulsifying agent, a resin, and so forth, are gradually added into a dispersion medium while stirring and are thoroughly blended in the medium. The ink of the present invention can be obtained by bringing about a stable dissolution or fine dispersion by the application of mechanical shear force using a disperser.

This “dispersion medium” in the present invention denotes water or an organic solvent or their mixture.

When an organic solvent is used as the dispersion medium for the ink of the present invention, the type of organic solvent can be established in conformity to the intended application of the colorant and is not particularly limited. The organic solvent can be exemplified by alcohols such as methanol, ethanol, modified ethanol, isopropanol, n-butanol, isobutanol, tert-butanol, sec-butanol, 2-methyl-2-butanol, 3-pentanol, octanol, benzyl alcohol, and cyclohexanol; glycols such as methyl cellosolve, ethyl cellosolve, diethylene glycol, and diethylene glycol monobutyl ether; ketones such as acetone, methyl ethyl ketone, and methyl isobutyl ketone; esters such as ethyl acetate, butyl acetate, ethyl propionate, and cellosolve acetate; aliphatic hydrocarbons such as hexane, octane, petroleum ether, and cyclohexane; aromatic hydrocarbons such as benzene, toluene, and xylene; halogenated hydrocarbons such as carbon tetrachloride, trichloroethylene, and tetrabromoethane; ethers such as diethyl ether, dimethyl glycol, trioxane, and tetrahydrofuran; acetals such as methylal and diethyl acetal; organic acids such as formic acid, acetic acid, and propionic acid; and sulfur-containing or nitrogen-containing organic compounds such as nitrobenzene, dimethylamine, monoethanolamine, pyridine, dimethyl sulfoxide, and dimethylformamide.

A polymerizable monomer may also be used as the organic solvent that can be used by the ink of the present invention. The polymerizable monomer is an addition-polymerizable monomer or a condensation polymerizable monomer and is preferably an addition-polymerizable monomer. Such polymerizable monomers can be exemplified by the following:

styrene monomers such as styrene, α-methylstyrene, α-ethylstyrene, o-methylstyrene, m-methylstyrene, p-methylstyrene, o-ethylstyrene, m-ethylstyrene, and p-ethylstyrene; acrylate monomers such as methyl acrylate, ethyl acrylate, propyl acrylate, butyl acrylate, octyl acrylate, dodecyl acrylate, stearyl acrylate, behenyl acrylate, 2-ethylhexyl acrylate, dimethylaminoethyl acrylate, diethylaminoethyl acrylate, acrylonitrile, and acrylamide; methacrylate monomers such as methyl methacrylate, ethyl methacrylate, propyl methacrylate, butyl methacrylate, octyl methacrylate, dodecyl methacrylate, stearyl methacrylate, behenyl dimethylaminoethyl methacrylate, diethylaminoethyl methacrylate, methacrylonitrile, and methacrylamide; olefinic monomers such as ethylene, propylene, butylene, butadiene, isoprene, isobutylene, and cyclohexene; vinyl halide monomers such as vinyl chloride, vinylidene chloride, vinyl bromide, and vinyl iodide; vinyl ester monomers such as vinyl acetate, vinyl propionate, and vinyl benzoate; vinyl ether monomers such as vinyl methyl ether, vinyl ethyl ether, and vinyl isobutyl ether; and vinyl ketone monomers such as vinyl methyl ketone, vinyl hexyl ketone, and methyl isopropenyl ketone.

A single one of these may be used or as necessary two or more may be used in combination.

A coloring compound having the structure given by general formula (1) is used as a colorant in the ink of the present invention, but, as long as the solubility or dispersibility of this coloring compound in the dispersion medium is not impaired, may as necessary be used in combination with another colorant.

Examples of this other co-usable colorant are C. I. Solvent Blue 14, 24, 25, 26, 34, 37, 38, 39, 42, 43, 44, 45, 48, 52, 53, 55, 59, 67, and 70; C. I. Solvent Red 8, 27, 35, 36, 37, 38, 39, 40, 49, 58, 60, 65, 69, 81, 83:1, 86, 89, 91, 92, 97, 99, 100, 109, 118, 119, 122, 127, and 218; and the various colorants that can be classified as derivatives of the preceding, but there is no limitation to these.

The content of the coloring compound of the present invention in the ink of the present invention, expressed per 100 mass parts of the dispersion medium, is preferably 1.0 to 30 mass parts, more preferably 2.0 to 20 mass parts, and even more preferably 3.0 to 15 mass parts. Within this range, a satisfactory tinting strength is obtained while an excellent dispersibility is also obtained for the colorant.

When water is used as the dispersion medium for the ink of the present invention, an emulsifying agent may be added as necessary in order to obtain an excellent dispersion stability for the coloring compound of the present invention and a co-used colorant. The emulsifying agent that can be added is not particularly limited and can be exemplified by cationic surfactants, anionic surfactants, and nonionic surfactants.

The cationic surfactant encompassed by this emulsifying agent can be exemplified by dodecylammonium chloride, dodecylammonium bromide, dodecyltrimethylammonium bromide, dodecylpyridinium chloride, dodecylpyridinium bromide, and hexadecyltrimethylammonium bromide.

The anionic surfactant encompassed by this emulsifying agent can be exemplified by fatty acid soaps such as sodium stearate and sodium dodecanoate, as well as by sodium dodecyl sulfate, sodium dodecylbenzene sulfate, and sodium lauryl sulfate.

The nonionic surfactant encompassed by this emulsifying agent can be exemplified by dodecyl polyoxyethylene ether, hexadecyl polyoxyethylene ether, nonylphenyl polyoxyethylene ether, lauryl polyoxyethylene ether, sorbitan monooleate polyoxyethylene ether, and monodecanoylsucrose.

A resin may also be added to the ink of the present invention. The resin that can be added to the ink of the present invention can be selected as appropriate in conformity with the intended application.

Examples are polystyrene resins, styrene copolymers, polyacrylic acid resins, polymethacrylic acid resins, polyacrylate resins, polymethacrylate resins, acrylic acid copolymers, methacrylic acid copolymers, polyester resins, polyvinyl ether resins, polyvinyl methyl ether resins, polyvinyl alcohol resins, polyvinyl butyral resins, polyurethane resins, and polypeptide resins.

A single one of these resins may be used or as necessary two or more may be used in combination.

The disperser referenced above is not particularly limited, and, for example, a rotational shear-type homogenizer, or a media-based disperser such as a ball mill, sand mill, or attritor, or a high-pressure counter collision-type disperser is preferably used.

As described in the preceding, the ink of the present invention, because it is formulated with a coloring compound of the present invention, can provide an ink that exhibits an excellent chromogenicity.

<The Thermal Transfer Recording Ink Sheet>

The thermal transfer recording ink sheet of the present invention will now be described.

The coloring compound of the present invention, due to its excellent chromogenicity, can be very suitably used in thermal transfer recording ink sheets.

The thermal transfer recording ink sheet of the present invention characteristically has a substrate and a color material layer formed on this substrate, wherein the color material layer contains the coloring compound of the present invention.

An exemplary embodiment of the thermal transfer recording ink sheet of the present invention has a substrate sheet and a color material layer formed on one side of this substrate sheet, wherein this color material layer contains a coloring compound of the present invention.

The thermal transfer recording ink sheet of the present invention can be produced, for example, as follows. A composition comprising a colorant containing the coloring compound with the structure in general formula (1), a binder resin, and as necessary a surfactant, a wax, and so forth, is gradually added while stirring into a dispersion medium and is thoroughly blended in the medium. Through the application of mechanical shear force using a disperser, this composition is stably dissolved in the dispersion medium or is stably dispersed in a finely particulate form in the dispersion medium, to produce a color material composition. This color material composition is then coated on a base film, i.e., the substrate, and the thermal transfer recording ink sheet of the present invention can be produced by drying. However, the present invention is not limited to thermal transfer recording ink sheets fabricated by this method.

Various resins can be used as the binder resin used in the thermal transfer recording ink sheet of the present invention. The following are preferred thereamong: water-soluble resins such as cellulose resins, polyacrylic acid resins, starch resins, and epoxy resins, and also organic solvent-soluble resins such as polyacrylate resins, polymethacrylate resins, polystyrene resins, polycarbonate resins, polyether sulfone resins, polyvinyl butyral resins, ethyl cellulose resins, acetylcellulose resins, polyester resins, AS resins, and phenoxy resins. A single one of these resins may be used or as necessary a combination of two or more may be used.

The dispersion media used for the ink as described above can be similarly used as the dispersion medium here. Specific examples are water and organic solvents.

The following, for example, are preferably used as the organic solvent: alcohols such as methanol, ethanol, isopropanol, and isobutanol; cellosolves such as methyl cellosolve and ethyl cellosolve; aromatic hydrocarbons such as toluene, xylene, and chlorobenzene; esters such as ethyl acetate and butyl acetate; ketones such as acetone, methyl ethyl ketone, methyl isobutyl ketone, and cyclohexanone; halogenated hydrocarbons such as methylene chloride, chloroform, and trichloroethylene; ethers such as tetrahydrofuran and dioxane; as well as N,N-dimethylformamide and N-methylpyrrolidone.

A single one of these organic solvents may be used or as necessary a combination of two or more may be used.

A thermal transfer recording ink sheet that exhibits an excellent chromogenicity can be obtained through the use of the coloring compound having the structure with general formula (1) as a colorant in the thermal transfer recording ink sheet of the present invention. In addition, another dye may also be used in combination for color matching in order to obtain desired spectral characteristics. There are no limitations on the co-usable dye as long as it does not substantially affect the lightness, chroma, or chromogenicity of the thermal transfer recording ink sheet of the present invention. Specific examples are C. I. Solvent Blue 14, 24, 25, 26, 34, 37, 38, 39, 42, 43, 44, 45, 48, 52, 53, 55, 59, 67, and 70; C. I. Solvent Red 8, 27, 35, 36, 37, 38, 39, 40, 49, 58, 60, 65, 69, 81, 83:1, 86, 89, 91, 92, 97, 99, 100, 109, 118, 119, 122, 127, and 218; and the various colorants that can be classified as derivatives of the preceding, but there is no limitation to these.

The use ratio (binder ratio:colorant) between the binder resin and the coloring compound of the present invention, viewed from the standpoint of the transferability, is preferably in the range from 1:2 to 2:1 as the mass ratio.

A surfactant can be added to the thermal transfer recording ink sheet of the present invention in order to bring about a satisfactory lubricity during heating by the thermal head (during printing). The surfactant that can be added can be exemplified by cationic surfactants, anionic surfactants, and nonionic surfactants.

This cationic surfactant can be exemplified by dodecylammonium chloride, dodecylammonium bromide, dodecyltrimethylammonium bromide, dodecylpyridinium chloride, dodecylpyridinium bromide, and hexadecyltrimethylammonium bromide.

This anionic surfactant can be exemplified by fatty acid soaps such as sodium stearate and sodium dodecanoate, as well as by sodium dodecyl sulfate, sodium dodecylbenzene sulfate, and sodium lauryl sulfate.

This nonionic surfactant can be exemplified by dodecyl polyoxyethylene ether, hexadecyl polyoxyethylene ether, nonylphenyl polyoxyethylene ether, lauryl polyoxyethylene ether, sorbitan monooleate polyoxyethylene ether, and monodecanoylsucrose.

A wax may be added to the thermal transfer recording ink sheet of the present invention in order to bring about a satisfactory lubricity in the absence of heating by the thermal head. The wax that may be added can be exemplified by polyethylene waxes, paraffin waxes, and fatty acid ester waxes, but is not limited to these.

Besides the additives considered above, as necessary an ultraviolet absorber, a preservative, an antioxidant, a static inhibitor, and a viscosity modifier may be added to the thermal transfer recording ink sheet of the present invention.

There are no particular limitations on the base film that is the substrate in the thermal transfer recording ink sheet of the present invention, and the following are provided as examples:

thin papers such as condenser paper and glassine paper and films of a plastic such as polyester, polycarbonate, polyamide, polyimide, and polyaramid.

These substrates are preferred for their excellent heat resistance. Among them, films of polyethylene terephthalate, which is a type of polyester, are even more preferred from the standpoint of mechanical strength, solvent resistance, and economics.

The substrate thickness is preferably 3 to 50 μm based on a consideration of the transferability.

In order to improve the heat resistance and the traveling behavior of the thermal head, a layer of a resin that contains a lubricant, high-slip heat-resistant fine particles, and a binder, is preferably disposed on the opposite side from the color material layer formed on the substrate. This lubricant can be exemplified by amino-modified silicone compounds and carboxy-modified silicone compounds; the heat-resistant fine particles can be exemplified by fine particles of, e.g., silica; and the binder can be exemplified by acrylic resins; however, there is no limitation to these.

The disperser is not particularly limited, and, for example, a rotational shear-type homogenizer, or a media-based disperser such as a ball mill, sand mill, or attritor, or a high-pressure counter collision-type disperser is preferably used.

The method for coating the base film is not particularly limited, and can be exemplified by methods that use, for example, a bar coater, gravure coater, reverse roll coater, rod coater, or air doctor coater. Viewed in terms of the transferability, the color material composition is preferably coated in an amount that provides a post-drying thickness for the color material layer in the range from 0.1 to 5 μm.

The heating means for heating the thermal transfer recording ink sheet of the present invention is not particularly limited, and, for example, not only can ordinary thermal head methods be used, but infrared radiation or laser light may also be used. In addition, use as an electrothermal dye transfer sheet is also possible through the use of an electrothermal film that generates heat by the introduction of electricity into the base film itself. As has been described in the preceding, the thermal transfer recording ink sheet of the present invention exhibits an excellent chromogenicity because it contains a coloring compound with the structure in general formula (1).

<The Color Filter Resist Composition>

The color filter resist composition of the present invention is described herebelow.

Due to its excellent chromogenicity, the coloring compound of the present invention is well suited for use in color filter resist compositions.

The color filter resist composition of the present invention contains a coloring compound having the structure in general formula (1) and at least either one of a binder resin and a polymerizable monomer.

The color filter resist composition of the present invention can be produced, for example, as follows.

The coloring compound with the structure in general formula (1), at least either one of a binder resin and a polymerizable monomer, and as necessary a polymerization initiator and a photoacid generator are gradually added with stirring to a dispersion medium and are thoroughly blended in the dispersion medium. The color filter resist composition of the present invention can be obtained by bringing about a stable dissolution or fine dispersion by the application of mechanical shear force using a disperser.

Binder resins usable in the color filter resist composition of the present invention are preferably binder resins for which either the region exposed to light or the region not exposed to light during the photoexposure step during pixel formation is dissolvable in an organic solvent, an aqueous base solution, water, or a commercial developer. Among these, binder resins having a composition developable by water or an aqueous base solution are preferred in terms of processability and waste treatment.

An example of such a binder resin is a resin provided by the copolymerization, at a suitable mixing ratio and by an already known procedure, of a hydrophilic polymerizable monomer and a lipophilic polymerizable monomer. The hydrophilic polymerizable monomer here can be exemplified by acrylic acid, methacrylic acid, N-(2-hydroxyethyl)acrylamide, N-vinylpyrrolidone, and ammonium salt-containing polymerizable monomers. The lipophilic polymerizable monomer can be exemplified by acrylate esters, methacrylate esters, vinyl acetate, styrene, and N-vinylcarbazole. This binder resin can be used as a negative-working resist by the combination of a radically polymerizable monomer having an ethylenically unsaturated group or an oxirane ring- or oxetane ring-containing cationically polymerizable monomer and a radical generator or an acid generator or base generator. A negative-working resist is a resist of the type in which, because photoexposure reduces the solubility in the developer, only the regions not exposed to light are removed by development.

Other binder resins can be exemplified by resins having the quinone diazide group, which undergoes photocleavage to produce a carboxy group, and resins that have an acid-cleavable group, as represented by the tert-butyl carbonate ester and tetrahydropyranyl ether of polyhydroxystyrene. This binder resin can be used as a positive-working resist by combination with an acid generator that produces acid upon photoexposure. A positive-working resist is a resist of the type in which, because the solubility in the developer is increased by photoexposure, only regions exposed to light are removed by development.

When the color filter resist composition of the present invention is a negative-working resist composition as described above, it can be formulated to contain—as a polymerizable monomer that undergoes photoexposure-induced addition polymerization—a photopolymerizable monomer having at least one ethylenically unsaturated double bond. This photopolymerizable monomer can be exemplified by compounds that have a boiling point of at least 100° C. at normal pressure and that have at least one addition-polymerizable ethylenically unsaturated group in the molecule. Examples are monofunctional acrylates such as polyethylene glycol monoacrylate, polyethylene glycol monomethacrylate, polypropylene glycol monoacrylate, polypropylene glycol monomethacrylate, phenoxyethyl acrylate, and phenoxyethyl methacrylate; polyfunctional acrylates and methacrylates such as polyethylene glycol diacrylate, polyethylene glycol dimethacrylate, polypropylene glycol diacrylate, polypropylene glycol dimethacrylate, trimethylolethane triacrylate, trimethylolethane trimethacrylate, trimethylolpropane triacrylate, trimethylolpropane trimethacrylate, trimethylolpropane diacrylate, trimethylolpropane dimethacrylate, neopentyl glycol diacrylate, neopentyl glycol dimethacrylate, pentaerythritol tetraacrylate, pentaerythritol tetramethacrylate, pentaerythritol triacrylate, pentaerythritol trimethacrylate, dipentaerythritol hexaacrylate, dipentaerythritol hexamethacrylate, dipentaerythritol pentaacrylate, dipentaerythritol pentamethacrylate, hexanediol diacrylate, hexanediol dimethacrylate, trimethylolpropane tri(acryloyloxypropyl) ether, tri(acryloyloxyethyl) isocyanurate, tri(acryloxyloxyethyl) cyanurate, glycerol triacrylate, and glycerol trimethacrylate; and polyfunctional acrylates and polyfunctional methacrylates as provided by the acrylation or methacrylation of an adduct of ethylene oxide and/or propylene oxide on a polyhydric alcohol such as trimethylolpropane or glycerol.

Additional examples are urethane acrylates, polyester acrylates, and the polyfunctional epoxy acrylates and epoxy methacrylates that are the reaction products of an epoxy resin and acrylic acid or methacrylic acid.

Among the preceding, the use of the following is preferred: trimethylolpropane triacrylate, trimethylolpropane trimethacrylate, pentaerythritol tetraacrylate, pentaerythritol tetramethacrylate, dipentaerythritol hexaacrylate, dipentaerythritol hexamethacrylate, dipentaerythritol pentaacrylate, and dipentaerythritol pentamethacrylate.

A single one of these photopolymerizable monomers may be used or as necessary a combination of two or more may be used.

The content of the photopolymerizable monomer is preferably 5 to 50 mass % and more preferably 10 to 40 mass % of the mass (total solids fraction) of the resist composition of the present invention. Having the content of the photopolymerizable monomer be in the indicated range makes it possible to suppress tackiness by the resist composition while providing an excellent sensitivity to photoexposure and an excellent pixel strength.

A photopolymerization initiator may be incorporated when the color filter resist composition of the present invention is a negative-working resist composition as described above. This photopolymerization initiator can be exemplified by vicinal polyketoaldonyl compounds, α-carbonyl compounds, acyloin ethers, polynuclear quinone compounds, triarylimidazole dimer/p-aminophenyl ketone combinations, and trioxadiazole compounds, while 2-benzyl-2-dimethylamino-1-(4-morpholinophenyl)butanone (trade name: Irgacure 369, BASF) is preferred among the preceding. This photopolymerization initiator is not required when an electron beam is used for pixel formation using the aforementioned resist composition.

A photoacid generator may as necessary also be added when the color filter resist composition of the present invention is a positive-working resist composition as described above. The known photoacid generators, such as salts between an anion and an onium ion, e.g., sulfonium, iodonium, selenonium, ammonium, and phosphonium, may be used as this photoacid generator, but there is no limitation to these.

The sulfonium ion here can be exemplified by triphenylsulfonium, tri-p-tolylsulfonium, tri-o-tolylsulfonium, tris(4-methoxyphenyl)sulfonium, 1-naphthyldiphenylsulfonium, diphenylphenacylsulfonium, phenylmethylbenzylsulfonium, 4-hydroxyphenylmethylbenzylsulfonium, dimethylphenacylsulfonium, and phenacyltetrahydrothiophenium.

The iodonium ion here can be exemplified by diphenyliodonium, di-p-tolyliodonium, bis(4-dodecylphenyl)iodonium, bis(4-methoxyphenyl)iodonium, and (4-octyloxyphenyl)phenyliodonium.

The selenonium ion here can be exemplified by triarylselenonium (triphenylselenonium, tri-p-tolylselenonium, tri-o-tolylselenonium, tris(4-methoxyphenyl)selenonium, 1-naphthyldiphenylselenonium, tris(4-fluorophenyl)selenonium, tri-1-naphthylselenonium, and tri-2-naphthylselenonium).

The ammonium ion here can be exemplified by tetraalkylammonium, e.g., tetramethylammonium, ethyltrimethylammonium, diethyldimethylammonium, triethylmethylammonium, tetraethylammonium, trimethyl-n-propylammonium, trimethylisopropylammonium, trimethyl-n-butylammonium, and trimethylisobutylammonium.

The phosphonium ion here can be exemplified by tetraphenylphosphonium, tetra-p-tolylphosphonium, tetrakis(2-methoxyphenyl)phosphonium, triphenylbenzylphosphonium, triphenylphenacylphosphonium, triphenylmethylphosphonium, triethylbenzylphosphonium, and tetraethylphosphonium.

The anion here can be exemplified by perhalate ions such as ClO₄⁻ and BrO₄⁻; halogenated sulfonate ions such as FSO₃⁻ and ClSO₃⁻; sulfate ions such as CH₃SO₄⁻. CF₃SO₄⁻ and HSO₄⁻; carbonate ions such as HCO₃⁻ and CH₃CO₃⁻; aluminate ions such as AlCl₄⁻ and AlF₄⁻; the hexafluorobismuthate ion; carboxylate ions such as CH₃COO⁻, CF₃C⁻, C₆H₅COO⁻, CH₃C₆H₄COO⁻, C₆F₅COO⁻, and CF₃C₆H₄COO⁻; arylborate ions such as B (C₆H₅)₄⁻ and CH₃CH₂CH₂CH₂B(C₆H₅)₃⁻; the thiocyanate ion; and the nitrate ion; but there is no limitation to the preceding.

Water and various organic solvents are examples of the dispersion medium that can be used to dissolve or disperse the color filter resist composition.

The organic solvent can be exemplified by cyclohexanone, ethyl cellosolve acetate, butyl cellosolve acetate, 1-methoxy-2-propyl acetate, diethylene glycol dimethyl ether, ethylbenzene, 1,2,4-trichlorobenzene, ethylene glycol diethyl ether, xylene, ethyl cellosolve, methyl n-amyl ketone, propylene glycol monomethyl ether, toluene, methyl ethyl ketone, ethyl acetate, methanol, ethanol, isopropanol, butanol, methyl isobutyl ketone, and petroleum-based solvents.

A single one of these organic solvents may be used or two or more may be used in combination.

The dispersion medium used for the color filter resist composition of the present invention may be the same medium as or a different medium from the dispersion medium used in the previously described ink, as long as the dispersibility of the coloring compound with the structure in general formula (1) is not impaired.

The color filter resist composition of the present invention is preferably used for the pixels constituting at least one color of the plurality of pixel colors (for example, red, green, blue) in a color filter in which two or more types of pixels having different spectral characteristics are arrayed adjacent to each other. This can provide a filter with an excellent lightness, an excellent extension of the chroma, and an excellent color tone. In addition, another dye may also be used in combination for color matching in order to obtain desired spectral characteristics. There are no particular limitations on the co-usable dye, which can be exemplified by C. I. Solvent Blue 14, 24, 25, 26, 34, 37, 38, 39, 42, 43, 44, 45, 48, 52, 53, 55, 59, 67, and 70, and by C. I. Solvent Red 8, 27, 35, 36, 37, 38, 39, 40, 49, 58, 60, 65, 69, 81, 83:1, 86, 89, 91, 92, 97, 99, 100, 109, 118, 119, 122, 127, and 218.

The content of the coloring compound of the present invention in the color filter resist composition is preferably 1.0 to 100.0 mass % of the mass (total solids fraction) of the color filter resist composition. 3.0 to 70.0 mass % is more preferred and 5.0 to 50.0 mass % is even more preferred.

Besides the additives considered above, as necessary an ultraviolet absorber may be added to the color filter resist composition of the present invention, as well as a silane coupling agent added for the purpose of improving the adhesiveness to the glass substrate when the filter is fabricated.

The disperser referenced above is not particularly limited, and, for example, a rotational shear-type homogenizer, or a media-based disperser such as a ball mill, sand mill, or attritor, or a high-pressure counter collision-type disperser is preferably used.

As described above, the color filter resist composition of the present invention exhibits an excellent chromogenicity because it contains a coloring compound with the structure given by general formula (1).

### EXAMPLES

The present invention is described in additional detail through the following examples and comparative examples, but the present invention is not limited to or by these examples. Unless specifically indicated otherwise, “parts” and “%” in the text are on a mass basis.

A nuclear magnetic resonance instrument (¹H-NMR, product name: ECA-400, JEOL Ltd.) was used as the analytical instrumentation for confirming the structure of the obtained coloring compounds.

[Synthesis of Dichlorosilylphthalocyanine]

Under a nitrogen atmosphere, tetrachlorosilane (1.8 parts) was added dropwise to a quinoline (10 parts) dispersion of 1,3-diiminoisoindoline (1.0 part) while paying attention to heat evolution. After the completion of the addition, the temperature was raised to 230° C. and stirring was performed for 5 hours. After the completion of the reaction, cooling to room temperature was carried out and the solid was filtered off under reduced pressure. The obtained solid was dispersed in N,N-dimethylformamide (abbreviated as DMF) and the temperature was raised to 80° C. A hot filtration was performed to obtain dichlorosilylphthalocyanine (yield=70%), which is a diaxial phthalocyanine.

<Coloring Compound Production Example 1: Production of the Compound (1) Described Above>

Under a nitrogen atmosphere, 60% sodium hydride (0.5 parts) was added in small portions to a toluene (10 parts) solution of cyclohexanemethanol (0.76 parts). The dichlorosilylphthalocyanine (1.0 part) was then added in small portions, followed by heating under reflux for 5 hours. After the completion of the reaction, dilution was carried out with n-hexane (50 parts) and the precipitated solid was filtered off. The obtained solid was washed with ethanol and ion-exchanged water to obtain a coloring compound (1) [compound (1)] of the present invention (yield=85%).

### [Analytical Results for Compound (1)]

¹H-NMR (400 MHz, DMF-d7, room temperature): δ (ppm)=9.75 (8H, dd), 8.55 (8H, dd), 0.39 (4H, s), 0.22 (6H, d), 1.12 (4H, s), 1.74 (8H, d), 2.29 (4H, d)

<Coloring Compound Production Example 2: Production of the Compound (13) Described Above>

A coloring compound (2) [compound (13)] of the present invention was obtained (yield=78%) by carrying out production using the same method as in Production Example 1, but changing the cyclohexanemethanol in Production Example 1 to adamantylmethanol (1.1 parts).

### [Analytical Results for Compound (13)]

¹H-NMR (400 MHz, DMF-d7, room temperature): δ (ppm)=9.76 (8H, s), 8.54 (8H, s), 0.78 (16H, m), 0.26 (5H, s), 2.54 (3H, s)

<Coloring Compound Production Example 3: Production of the Compound (15) Described Above>

A coloring compound (3) [compound (15)] of the present invention was obtained (yield=73%) by carrying out production using the same method as in Production Example 1, but changing the cyclohexanemethanol in Production Example 1 to 3,5-dimethyl-1-adamantanemethanol (1.1 parts).

### [Analytical Results for Compound (15)]

¹H-NMR (400 MHz, DMF-d7, room temperature): δ (ppm)=9.78 (8H, s), 8.52 (8H, s), 0.81 (10H, m), 1.13 (12, m), 3.89 (4H, d), 1.04 (12H, s)

<Coloring Compound Production Example 4: Production of the Compound (17) Described Above>

A coloring compound (4) [compound (17)] of the present invention was obtained (yield=82%) by carrying out production using the same method as in Production Example 1, but changing the cyclohexanemethanol in Production Example 1 to norbornane-2-methanol (1.0 part).

### [Analytical Results for Compound (17)]

¹H-NMR (400 MHz, DMF-d7, room temperature): δ (ppm)=9.75 (8H, dd), 8.56 (8H, dd), 0.59 (4H, dd), 1.26 (4H, dd), 1.74 (12H, m)

[Synthesis of tert-butyldichlorosilylphthalocyanine]

Under a nitrogen atmosphere, tetrachlorosilane (1.8 parts) was added dropwise to a quinoline (10 parts) dispersion of 5-t-Bu-1,3-diiminoisoindoline (1.0 part) while paying attention to heat evolution. After the completion of the addition, the temperature was raised to 230° C. and stirring was performed for 5 hours. After the completion of the reaction, cooling to room temperature was carried out and the solid was filtered off under reduced pressure. The obtained solid was dispersed in N,N-dimethylformamide (abbreviated as DMF) and the temperature was raised to 80° C. A hot filtration was performed to obtain tert-butyldichlorosilylphthalocyanine (yield=73%), which is a diaxial phthalocyanine.

### <Coloring Compound Production Example 5: Production of the Compound (35) Described Above>

Under a nitrogen atmosphere, 60% sodium hydride (0.5 parts) was added in small portions to a toluene (10 parts) solution of adamantylmethanol (1.1 parts). The above-described tert-butyldichlorosilylphthalocyanine (1.0 part) was then added in small portions, followed by heating under reflux for 5 hours. After the completion of the reaction, dilution was carried out with n-hexane (50 parts) and the precipitated solid was filtered off. The obtained solid was washed with ethanol and ion-exchanged water to obtain a coloring compound (5) [compound (35)] of the present invention (yield=76%).

### [Analytical Results for Compound (35)]

¹H-NMR (400 MHz, DMF-d7, room temperature): δ (ppm)=9.78 (8H, s), 8.56 (8H, s), 2.54 (3H, s), 1.35 (36H, s), 0.81 (16H, m), 0.26 (5H, s)

### <Coloring Compound Production Example 6: Production of the Compound (40) Described Above>

A coloring compound (6) [compound (40)] of the present invention was obtained (yield=83%) by carrying out production using the same method as in Production Example 5, but changing the adamantylmethanol (1.1 parts) in Production Example 5 to cyclohexanemethanol (0.76 parts).

### [Analytical Results for Compound (40)]

¹H-NMR (400 MHz, DMF-d7, room temperature): δ (ppm)=9.75 (8H, dd), 8.55 (8H, dd), 0.39 (4H, s), 0.22 (6H, d), 1.12 (4H, s), 1.74 (8H, d), 2.29 (4H, d), 1.29 (36H, s)

### <Coloring Compound Production Example 7: Production of the Compound (41) Described Above>

A coloring compound (7) [compound (41)] of the present invention was obtained (yield=80%) by carrying out production using the same method as in Production Example 5, but changing the adamantylmethanol (1.1 parts) in Production Example 5 to norbornane-2-methanol (1.0 part).

### [Analytical Results for Compound (41)]

¹H-NMR (400 MHz, DMF-d7, room temperature): δ (ppm)=9.75 (8H, dd), 8.56 (8H, dd), 0.59 (4H, dd), 1.26 (4H, dd), 1.74 (12H, m), 1.32 (36H, s)

### Example 1

### Production Example for Ink (1)

An ink (1) of the present invention was obtained by dissolving 5 parts of coloring compound (1) in 100 parts of chloroform and filtering off the insoluble fraction using a filter (filter diameter: 4 μmØ).

### Examples 2 to 7

### Production Examples for Inks (2) to (7)

Inks (2) to (7) were obtained by the same procedure as in the Production Example for Ink (1), but respectively changing the coloring compound (1) in the Production Example for Ink (1) to coloring compounds (2) to (7).

### Comparative Examples 1 to 4

### Production Examples for Comparative Inks (1) to (4)

Comparative inks (1) to (4) were obtained by the same procedure as in the Production Example for Ink (1), but respectively changing the coloring compound (1) in the Production Example for Ink (1) to the comparative compounds (1) to (4) indicated below. The t-Bu in comparative compounds (1) and (3) represents the tert-butyl group. Comparative compound (1) is a copper phthalocyanine compound that exhibits a high solvent solubility, while comparative compounds (2) to (4) are Si phthalocyanine compounds close to the structure of the coloring compound of the present invention.

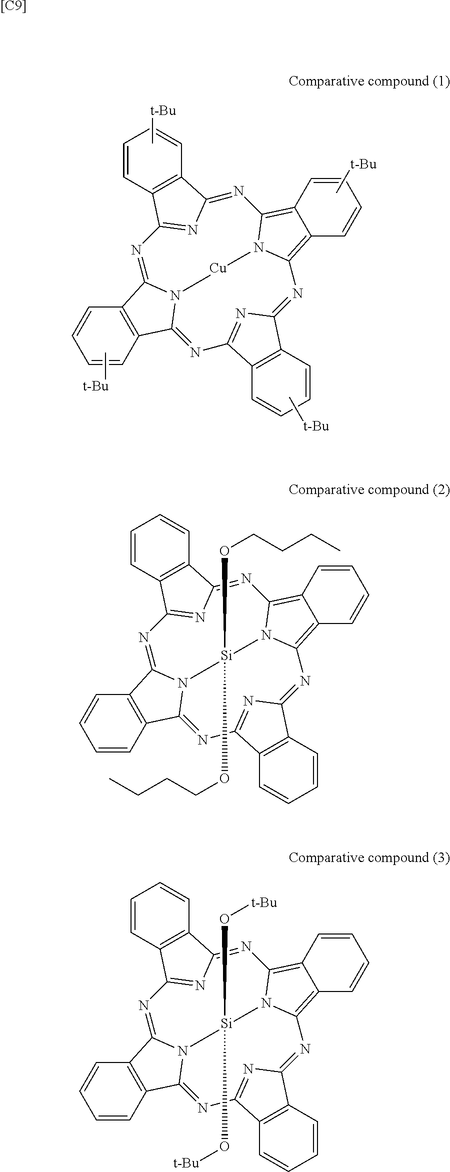

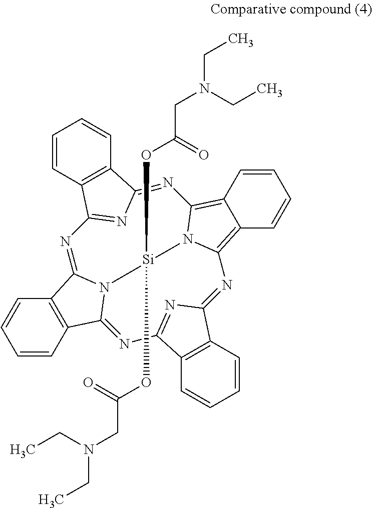

<Preparation of Film Samples>

Film samples were prepared by forming films of inks (1) to (7) and comparative inks (1) to (4) on glass substrates by spin coating and air drying overnight.

### [Evaluation of the Chromogenicity]

The UV spectrum was measured (UV-3600, UV-VIS-NIR SPECTROPHOTOMETER, Shimadzu Corporation) on the obtained film samples and the chromogenicity was evaluated.

A lower intensity for the Q band, which is observed at an absorption wavelength from 600 to 700 nm, indicates a lower chromogenicity. As a consequence, the intensity ratio between the Q band and the Soret band, which is observed in the range from 200 to 300 nm, functions as a parameter representative of the chromogenicity. The chromogenicity was defined as indicated below.

A determination of an excellent chromogenicity was made in the evaluation, carried out as indicated below, when the Q band intensity/Soret band intensity was greater than or equal to 1.30.

A: Q band intensity/Soret band intensity greater than or equal to 1.80
B: Q band intensity/Soret band intensity greater than or equal to 1.30, but less than 1.80
C: Q band intensity/Soret band intensity less than 1.30

The results of the evaluations for Examples 1 to 7 and Comparative Examples 1 to 4 are collected in Table 1.

TABLE 1

| | | Q band intensity/ | |
|---|---|---|---|
| | compound | Soret band intensity | chromogenicity |
| Example 1 | compound (1) | 1.59 | B |
| Example 2 | compound (13) | 2.22 | A |
| Example 3 | compound (15) | 2.36 | A |
| Example 4 | compound (17) | 1.76 | B |
| Example 5 | compound (35) | 7.02 | A |
| Example 6 | compound (40) | 5.63 | A |
| Example 7 | compound (41) | 6.68 | A |
| Comparative | comparative | 0.56 | C |
| Example 1 | compound (1) | | |
| Comparative | comparative | 0.68 | C |
| Example 2 | compound (2) | | |
| Comparative | comparative | 0.98 | C |
| Example 3 | compound (3) | | |
| Comparative | comparative | 1.17 | C |
| Example 4 | compound (4) | | |

As is clear from Table 1, the inks containing a coloring compound of the present invention with the structure given in general formula (1) are shown to have a chromogenicity superior to that of the comparative compounds.

### <Preparation of Color Filter Resist Compositions>

### Example 8

A color filter ink (1) was obtained by carrying out dispersion for 1 hour using an attritor (Mitsui Mining Co., Ltd.) on a mixture of 12 parts of the coloring compound (1) of the present invention and 120 parts of cyclohexanone.

22 parts of this color filter ink (1) was then gradually added to a solution of 96 parts of cyclohexanone that contained 0.4 parts of 2-benzyl-2-dimethylamino-1-(4-morpholinophenyl)butanone (photopolymerization initiator), 1.3 parts dipentaerythritol pentaacrylate, and 6.7 parts of an acrylic copolymer (weight-average molecular weight=10,000) that had a monomer composition of 40 mass % n-butyl methacrylate, 30 mass % acrylic acid, and 30 mass % hydroxyethyl methacrylate, and stirring was carried out for 3 hours at room temperature. This was filtered across a 1.5-μm filter to obtain a color filter resist composition (1) of the present invention.

This color filter resist composition (1) was spin coated on a glass substrate and then dried for 3 minutes at 90° C. followed by photoexposure over the whole surface and post-curing at 180° C. to produce a color filter (1).

### Examples 9 to 14

Color filters (2) to (7) were obtained using the same procedure as in the production example in Example 8, but respectively changing the coloring compound (1) in Example 8 to coloring compounds (2) to (7).

### Comparative Examples 5 to 8

Comparative color filters (1) to (4) were obtained using the same procedure as in Example 8, but changing the coloring compound (1) in Example 8 to comparative compounds (1) to (4).

<Preparation of Thermal Transfer Recording Ink Sheets>

### Example 15

13.5 parts of coloring compound (1), 45 parts of methyl ethyl ketone, and 45 parts of toluene were mixed to obtain a mixed solution. While stirring, 5 parts of a polyvinyl butyral resin (Denka 3000-K, Denki Kagaku Kogyo Kabushiki Kaisha) was added in small portions to this mixed solution to obtain an ink (1) for a thermal transfer recording ink sheet of the present invention.

This ink (1) for a thermal transfer recording ink sheet was coated on a 4.5 μm-thick polyethylene terephthalate film (Lumirror, Toray Industries, Inc.) so as to provide a post-drying thickness of 1 μm, followed by drying to produce a thermal transfer recording ink sheet (1).

### Examples 16 to 21

Individual thermal transfer recording ink sheets (2) to (7) were obtained using the same procedure as in Example 15, but changing the coloring compound (1) in the production example in Example 15 to coloring compounds (2) to (7), respectively.

### Comparative Examples 9 to 12

Comparative thermal transfer recording ink sheets (1), (2), (3), and (4) were obtained using the same procedure as in Example 15, but changing the coloring compound (1) in Example 15 to comparative compounds (1) to (4), respectively.

[Evaluation of the Chromogenicity]

The UV spectrum was measured (UV-3600, UV-VIS-NIR SPECTROPHOTOMETER, Shimadzu Corporation) on the obtained color filters and thermal transfer recording ink sheets and the chromogenicity was evaluated.

A lower intensity for the Q band, which is observed at an absorption wavelength from 600 to 700 nm, indicates a lower chromogenicity. As a consequence, the intensity ratio between the Q band and the Soret band, which is observed in the range from 200 to 300 nm, functions as a parameter representative of the chromogenicity. The chromogenicity was defined as indicated below.

A determination of an excellent chromogenicity was made in the evaluation, carried out as indicated below, when the Q band intensity/Soret band intensity was greater than or equal to 1.30.

A: Q band intensity/Soret band intensity greater than or equal to 1.80
B: Q band intensity/Soret band intensity greater than or equal to 1.30, but less than 1.80
C: Q band intensity/Soret band intensity less than 1.30

The results of the evaluations for Examples 8 to 21 and Comparative Examples 5 to 12 are collected in Table 2.

TABLE 2

| | | | Q band | |
|---|---|---|---|---|
| | | | intensity/ | |
| | | | Soret band | chromo- |
| | compound | application | intensity | genicity |
| Example 8 | compound (1) | color filter | 1.71 | B |
| Example 9 | compound (13) | color filter | 2.38 | A |
| Example 10 | compound (15) | color filter | 2.41 | A |
| Example 11 | compound (17) | color filter | 1.71 | B |
| Example 12 | compound (35) | color filter | 6.88 | A |
| Example 13 | compound (40) | color filter | 5.41 | A |
| Example 14 | compound (41) | color filter | 6.43 | A |
| Example 15 | compound (1) | thermal | 1.66 | B |
| | | transfer sheet | | |
| Example 16 | compound (13) | thermal | 2.16 | A |
| | | transfer sheet | | |
| Example 17 | compound (15) | thermal | 2.49 | A |
| | | transfer sheet | | |
| Example 18 | compound (17) | thermal | 1.79 | B |
| | | transfer sheet | | |
| Example 19 | compound (35) | thermal | 6.72 | A |
| | | transfer sheet | | |
| Example 20 | compound (40) | thermal | 5.29 | A |
| | | transfer sheet | | |
| Example 21 | compound (41) | thermal | 6.22 | A |
| | | transfer sheet | | |
| Comparative | comparative | color filter | 0.53 | C |
| Example 5 | compound (1) | | | |
| Comparative | comparative | color filter | 0.64 | C |
| Example 6 | compound (2) | | | |
| Comparative | comparative | color filter | 0.91 | C |
| Example 7 | compound (3) | | | |
| Comparative | comparative | color filter | 1.10 | C |
| Example 8 | compound (4) | | | |
| Comparative | comparative | thermal | 0.54 | C |
| Example 9 | compound (1) | transfer sheet | | |
| Comparative | comparative | thermal | 0.64 | C |
| Example 10 | compound (2) | transfer sheet | | |
| Comparative | comparative | thermal | 0.85 | C |
| Example 11 | compound (3) | transfer sheet | | |
| Comparative | comparative | thermal | 1.03 | C |
| Example 12 | compound (4) | transfer sheet | | |

As is clear from Table 2, the color filters and thermal transfer recording ink sheets containing a coloring compound of the present invention with the structure given in general formula (1) are shown to have an excellent chromogenicity.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-183476, filed Aug. 22, 2012, which is hereby incorporated by reference herein in its entirety.

1. A coloring compound having a structure represented by general formula (1): 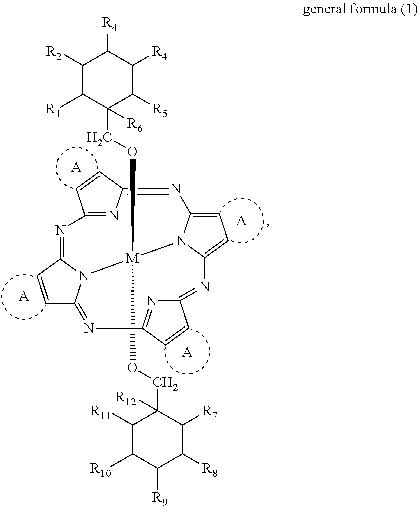
wherein, in the general formula (1), R₁ to R₆ each independently represents a hydrogen atom, an alkyl group, a hydroxyl group, an amino group, a carboxy group, an aryl group, an aralkyl group, —CH₂OH, or —CH₂—O—CH═CH₂, or an atomic group as required to form a saturated cyclic hydrocarbon ring by the bonding of any two or more of R₁ to R₆ to each other;
R₇ to R₁₂ each independently represents a hydrogen atom, an alkyl group, a hydroxyl group, an amino group, a carboxy group, an aryl group, an aralkyl group, —CH₂OH, or —CH₂—O—CH═CH₂, or an atomic group as required to form a saturated cyclic hydrocarbon ring by the bonding of any two or more of R₇ to R₁₂ to each other; 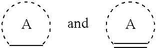
each independently represents a benzene ring having a tert-butyl group; and
M represents at least one metal atom selected from the group consisting of Si, Ge, and Sn.

2. The coloring compound according to claim 1, wherein:
(i) R₁ to R₆ are atomic groups as required to form a saturated cyclic hydrocarbon ring by the bonding of any two or more of R₁ to R₆ to each other; or
(ii) R₇ to R₁₂ are atomic groups as required to form a saturated cyclic hydrocarbon ring by the bonding of any two or more of R₇ to R₁₂ to each other.

3. The coloring compound according to claim 1, wherein the saturated cyclic hydrocarbon ring having R₁ to R₆ or the saturated cyclic hydrocarbon ring having R₇ to R₁₂ is an adamantane ring.

4-6. (canceled)

7. The coloring compound according to claim 1, wherein M in the general formula (1) is Si.

8. An ink comprising a dispersion medium and the coloring compound according to claim 1.

9. A color filter resist composition comprising at least either one of a binder resin and a polymerizable monomer, and the coloring compound according to claim 1.

10. A thermal transfer recording ink sheet having a substrate and a color material layer formed on the substrate, the color material layer containing the coloring compound according to claim 1.
